(19) United States
(12) Patent Application Publication
(10) Pub. No.: US 2020/0097118 A1
(43) Pub. Date: Mar. 26, 2020

(54) METHOD FOR USING VARIOUS KINDS OF ELECTRONIC PENS AND ELECTRONIC DEVICE THEREFOR

(71) Applicant: Samsung Electronics Co., Ltd., Gyeonggi-do (KR)

(72) Inventors: Byunghoon KANG, Gyeonggi-do (KR); Joohoon LEE, Gyeonggi-do (KR)

(21) Appl. No.: 16/617,010

(22) PCT Filed: Mar. 29, 2018
(86) PCT No.: PCT/KR2018/003687

§ 371 Date: Nov. 26, 2019

(30) Foreign Application Priority Data
May 26, 2017 (KR) 10-2017-0065098

(51) Int. Cl. G06F 3/041; G06F 3/0354; G06F 3/038

(52) U.S. Cl. CPC G06F 3/0416; G06F 3/038; G06F 3/03545

(57) ABSTRACT

Various embodiments of the present invention relate to a method for using various kinds of electronic pens, and an electronic device therefor. The method comprises the steps of: detecting a first electronic pen; detecting a release of the first electronic pen; and, on the basis of the detection of the release of the first electronic pen, performing a scan of the electronic pen on the basis of updated scan variables of the electronic pen. Other embodiments are also possible.

### TECHNICAL FIELD

Various embodiments of the disclosure relate to a method for using various kinds of electronic pens and an electronic device therefor.

### BACKGROUND ART

Electronic devices can detect a user input and can perform a function according to the detected user input. A user input refers to an input that can be made by a user directly using a finger or an electronic pen. In particular, an electronic pen may be manufactured by various methods to perform various functions of an electronic device. Accordingly, respective electronic pens may operate on the basis of different protocols.

### DISCLOSURE OF INVENTION

### Technical Problem

An electronic pen may be designed such that only one predetermined electronic pen is recognized. For example, an electronic pen may be detected on the basis of a protocol or frequency band corresponding to a predetermined electronic pen.

Therefore, various embodiments of the disclosure provide a device and a method for recognizing various kinds of electronic pens operating on the basis of different protocols in an electronic device.

The technical subjects pursued in the disclosure may not be limited to the above mentioned technical subjects, and other technical subjects which are not mentioned may be clearly understood, through the following descriptions, by those skilled in the art of the disclosure.

### Solution to Problem

According to various embodiments of the disclosure, an operating method of an electronic device using various types of electronic pens may include: detecting a first electronic pen; detecting release of the first electronic pen; and scanning an electronic pen on the basis of an updated scan variable of the electronic pen on the basis of detection of the release of the first electronic pen.

According to various embodiments of the disclosure, an operating method of an electronic device may include: scanning a first electronic pen; determining whether the first electronic pen is detected; updating a scan variable of an electronic pen and determining whether release of the detected first electronic pen is detected when the first electronic pen is detected; scanning a second electronic pen and determining whether the second electronic pen is detected when the first electronic pen is not detected; and updating the scan variable of the electronic pen and determining whether release of the detected second electronic pen is detected when the second electronic pen is detected, and the first electronic pen and the second electronic pen may operate on the basis of at least partly different protocols.

According to various embodiments of the disclosure, an electronic device may include: a sensor module; a processor configured to be electrically connected with the sensor module; and a memory configured to be electrically connected with the processor, wherein the memory may be configured to store instructions to, when executed, enable the processor to: detect a first electronic pen using the sensor module; detect release of the first electronic pen using the sensor module; and scan an electronic pen on the basis of an updated scan variable of the electronic pen on the basis of detection of the release of the first electronic pen.

According to various embodiments of the disclosure, an electronic device may include: a sensor module; a processor configured to be electrically connected with the sensor module; and a memory configured to be electrically connected with the processor, wherein the memory may be configured to store instructions to, when executed, enable the processor to: scan a first electronic pen using the sensor module; determine whether the first electronic pen is detected using the sensor module; update a scan variable of an electronic pen and determine whether release of the detected first electronic pen is detected when the first electronic pen is detected; scan a second electronic pen and determine whether the second electronic pen is detected using the sensor module when the first electronic pen is not detected; and update the scan variable of the electronic pen and determine whether release of the detected second electronic pen is detected when the second electronic pen is detected, and the first electronic pen and the second electronic pen may operate on the basis of at least partly different protocols.

### Advantageous Effects of Invention

A method and an electronic device therefor according to various embodiments of the disclosure can recognize electronic pens having different protocols, thus improving user convenience for the electronic pens.

A method and an electronic device therefor according to various embodiments of the disclosure may update a scan variable of an electronic pen on the basis of the usage state of the electronic pen, thereby increasing the detection speed of the electronic pen and reducing power consumption for detecting the electronic pen.

### BRIEF DESCRIPTION OF DRAWINGS

FIG. 1A illustrates a network environment including an electronic device according to various embodiments of the disclosure;

FIG. 1B illustrates the configuration of an electronic device that detects an electronic pen according to various embodiments of the disclosure;

FIG. 1C and FIG. 1D are block diagrams illustrating the configuration of a touch panel that detects an electronic pen according to various embodiments of the disclosure;

FIG. 2 is a block diagram illustrating an electronic device according to various embodiments of the disclosure;

FIG. 3 is a block diagram illustrating a program module according to various embodiments;

FIG. 4 is a flowchart illustrating an operating method of an electronic device according to various embodiments of the disclosure;

FIG. 5 is a flowchart illustrating a method for updating a scan variable of an electronic pen according to various embodiments of the disclosure;

FIG. 6 to FIG. 9 are diagrams for illustrating a method for updating a scan variable of an electronic pen according to various embodiments of the disclosure;

FIG. 10 is a flowchart illustrating a method for updating a scan variable of an electronic pen on the basis of a usage history according to various embodiments of the disclosure;

FIG. 11 is a diagram for illustrating a method for updating a scan variable of an electronic pen on the basis of a usage history according to various embodiments of the disclosure;

FIG. 12 is a flowchart illustrating a method for deactivating an electronic pen according to various embodiments of the disclosure;

FIG. 13 illustrates a method for deactivating an electronic pen according to various embodiments of the disclosure;

FIG. 14 is a flowchart illustrating a method for updating a scan variable of an electronic pen according to various embodiments of the disclosure;

FIG. 15A and FIG. 15B are flowcharts illustrating an operating method of an electronic device according to various embodiments of the disclosure; and

FIG. 16 is a flowchart illustrating a method for updating a scan variable of a connected electronic pen according to various embodiments of the disclosure.

### BEST MODE FOR CARRYING OUT THE INVENTION

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents. With respect to the descriptions of the accompanying drawings, like reference numerals refer to like elements. The terms of a singular form may include plural forms unless they have a clearly different meaning in the context. For example, the expressions “A or B,” or “at least one of A and/or B” may indicate A and B, A, or B. The terms such as “1st,” “2nd,” “first,” “second,” and the like used herein may refer to modifying various different elements of various embodiments of the present disclosure, but are not intended to limit the elements. In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HDM)), a textile- or clothing-integrated-type device (e.g., an electronic apparel), a body-attached-type device (e.g., a skin pad or a tattoo), or a bio-implantable-type device (e.g., an implantable circuit). In some various embodiments of the present disclosure, an electronic device may be a home appliance. The smart home appliance may include at least one of, for example, a television (TV), a digital versatile disc (DVD) player, an audio, a refrigerator, an air conditioner, a cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, or an electronic picture frame.

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like). According to various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of new technology. The term “user” used herein may refer to a person who uses an electronic device or may refer to a device (e.g., an artificial intelligence electronic device) that uses an electronic device.

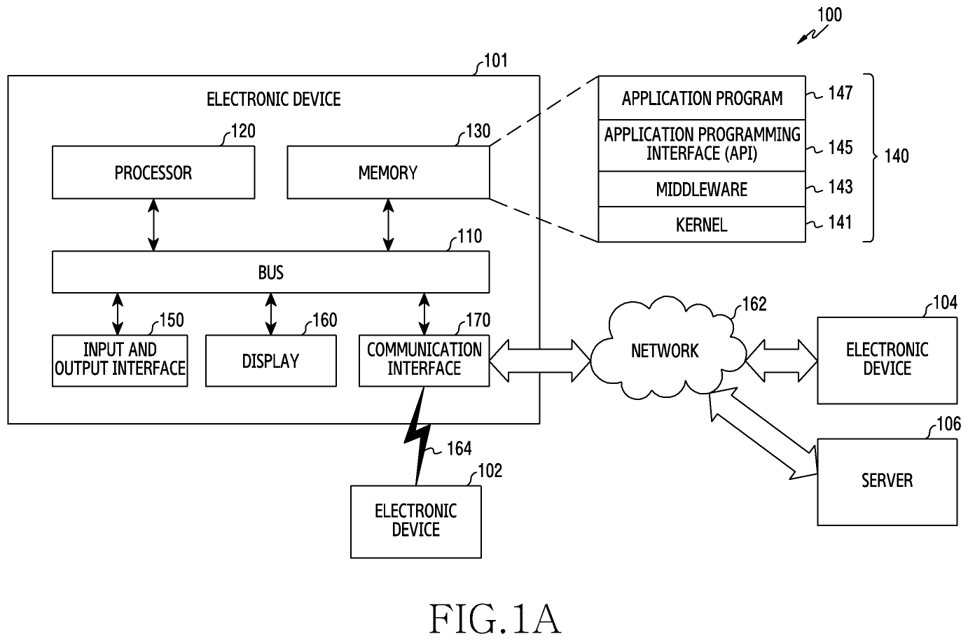

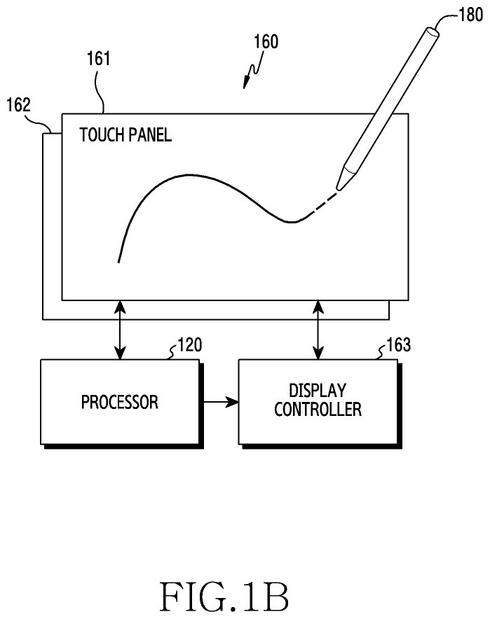

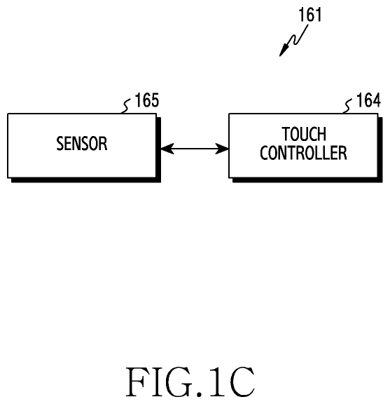

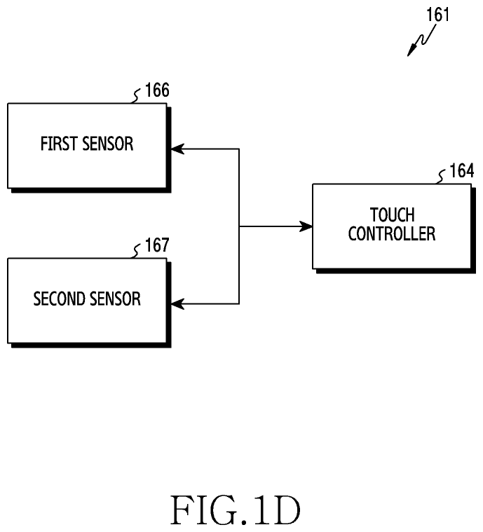

FIG. 1A illustrates a network environment including an electronic device according to various embodiments of the disclosure.

An electronic device 101 in a network environment 100 according to various embodiments of the present disclosure will be described with reference to FIG. 1A. The electronic device 101 may include a bus 110, a processor 120, a memory 130, an input/output interface 150, a display 160, and a communication interface 170. In various embodiments of the present disclosure, at least one of the foregoing elements may be omitted or another element may be added to the electronic device 101. The bus 110 may include a circuit for connecting the above-mentioned elements 110 to 170 to each other and transferring communications (e.g., control messages and/or data) among the above-mentioned elements. The processor 120 may include at least one of a central processing unit (CPU), an application processor (AP), or a communication processor (CP). The processor 120 may perform data processing or an operation related to communication and/or control of at least one of the other elements of the electronic device 101.

According to one embodiment, the processor 120 may scan various types of electronic pens according to a scan variable designated through a touch panel 161 (illustrated in FIG. 1C). For example, the processor 120 may detect a first electronic pen using the touch panel 161 during a scan period corresponding to the first electronic pen. For example, the processor 120 may obtain at least one coordinate according to the first electronic pen detected using the touch panel 161.

The processor 120 may update a scan variable of an electronic pen when the first electronic pen is detected. For example, the processor 120 may increase a scan variable of the first electronic pen most recently detected and may decrease a scan variable of a second electronic pen.

For example, when the release of the first electronic pen is detected through the touch panel 161, the processor 120 may scan an electronic pen on the basis of the updated scan variable of the electronic pen upon detecting the release of the first electronic pen. For example, the processor 120 may scan an electronic pen according to the increased scan variable of the first electronic pen and the decreased scan variable of the second electronic pen.

According to one embodiment, the processor 120 may update the priority of a designated electronic pen. For example, the processor 120 may increase the priority of the first electronic pen.

For example, the processor 120 may update a scan variable of an electronic pen on the basis of the updated priority. For example, the processor 120 may increase the driving frequency of the first electronic pen to be higher than the driving frequency of the second electronic pen.

For example, the processor 120 may scan an electronic pen on the basis of the updated scan variable using the touch panel 161. In one example, the processor 120 may scan an electronic pen by driving an idle mode for recognizing the first electronic pen and an idle mode for recognizing the second electronic pen at a certain ratio.

According to one embodiment, the processor 120 may check the usage history of the first electronic pen. For example, the processor 120 may check the usage history of an electronic pen generated in the electronic device in the memory of the electronic device 101.

For example, when there is no usage history of the first electronic pen, the processor 120 may update the scan variable of the designated electronic pen and may scan an electronic pen on the basis of the updated scan variable.

For example, when there is the usage history of the first electronic pen, the processor 120 may update the scan variable on the basis of the usage history of the first electronic pen. The processor 120 may scan an electronic pen on the basis of the scan variable updated on the basis of the usage history.

According to one embodiment, the processor 120 may check the usage history of an electronic pen and may identify an electronic pen that has not been used for a specified period or longer on the basis of the checked usage history of the electronic pen.

For example, when there is no electronic pen that has not been used for the specified period or longer, the processor 120 may periodically check the usage history of the electronic pen.

For example, when there is an electronic pen that has not been used for the specified period or longer, the processor 120 may display a notification for selecting whether to deactivate the electronic pen using a display panel 162 (illustrated in FIG. 1B).

For example, the processor 120 may determine whether a user's input to deactivate the electronic pen is detected using the touch panel 161.

For example, when the user's input to deactivate the electronic pen is detected, the processor 120 may deactivate the electronic pen.

For example, when the user's input to deactivate the electronic pen is not detected, the processor 120 may update a scan variable of the electronic pen that has not been used for the specified period or longer. The processor 120 may scan the electronic pen on the basis of the updated scan variable of the electronic pen.

According to one embodiment, the processor 120 may update a scan variable according to the number of times the coordinates of the first electronic pen are obtained. For example, the processor 120 may determine whether the coordinates of the detected first electronic pen are updated. For example, when it is determined that the coordinates of the first electronic pen are updated, the processor 120 may further update the scan variable of the electronic pen.

For example, the processor 120 may determine whether the first electronic pen is released using the touch panel 161. When it is determined that the first electronic pen is released, the processor 120 may scan an electronic pen according to the already updated scan variable without further updating the scan variable.

According to one embodiment, when an electronic pen is connected, the processor 120 may update a scan variable. For example, when it is detected that an electronic pen is connected to the electronic device, the processor 120 may update a scan variable of the connected electronic pen, may scan the electronic pen according to the updated scan variable, and may obtain the coordinates on the basis of the connected electronic pen.

The memory 130 may include a volatile memory and/or a nonvolatile memory. The memory 130 may store instructions or data related to at least one of the other elements of the electronic device 101. According to an embodiment of the present disclosure, the memory 130 may store software and/or a program 140.

The program 140 may include, for example, a kernel 141, a middleware 143, an application programming interface (API) 145, and/or an application program (or an application) 147. At least a portion of the kernel 141, the middleware 143, or the API 145 may be referred to as an operating system (OS). The kernel 141 may control or manage system resources (e.g., the bus 110, the processor 120, the memory 130, or the like) used to perform operations or functions of other programs (e.g., the middleware 143, the API 145, or the application program 147). Furthermore, the kernel 141 may provide an interface for allowing the middleware 143, the API 145, or the application program 147 to access individual elements of the electronic device 101 in order to control or manage the system resources.

The middleware 143 may serve as an intermediary so that the API 145 or the application program 147 communicates and exchanges data with the kernel 141. Furthermore, the middleware 143 may handle one or more task requests received from the application program 147 according to a priority order. For example, the middleware 143 may assign at least one application program 147 a priority for using the system resources (e.g., the bus 110, the processor 120, the memory 130, or the like) of the electronic device 101. For example, the middleware 143 may handle the one or more task requests according to the priority assigned to the at least one application. The API 145, which is an interface for allowing the application 147 to control a function provided by the kernel 141 or the middleware 143, may include, for example, at least one interface or function (e.g., instructions) for file control, window control, image processing, character control, or the like. The input/output interface 150 may serve to transfer an instruction or data input from a user or another external device to (an)other element(s) of the electronic device 101. Furthermore, the input/output interface 150 may output instructions or data received from (an)other element(s) of the electronic device 101 to the user or another external device.

The display 160 may include, for example, a liquid crystal display (LCD), a light-emitting diode (LED) display, an organic light-emitting diode (OLED) display, a microelectromechanical systems (MEMS) display, or an electronic paper display. The display 160 may present various content (e.g., a text, an image, a video, an icon, a symbol, or the like) to the user. The display 160 may include a touch screen, and may receive a touch, gesture, proximity or hovering input from an electronic pen or a part of a body of the user.

The communication interface 170 may set communications between the electronic device 101 and an external device (e.g., a first external electronic device 102, a second external electronic device 104, or a server 106). For example, the communication interface 170 may be connected to a network 162 via wireless communications or wired communications so as to communicate with the external device (e.g., the second external electronic device 104 or the server 106).

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 164. The short-range communications may include at least one of wireless fidelity (Wi-Fi), Bluetooth, near field communication (NFC), magnetic stripe transmission (MST), or GNSS. The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 232 (RS-232), plain old telephone service (POTS), or the like.

The network 162 may include at least one of telecommunications networks, for example, a computer network (e.g., local area network (LAN) or wide area network (WAN)), the Internet, or a telephone network.

The types of the first external electronic device 102 and the second external electronic device 104 may be the same as or different from the type of the electronic device 101. According to an embodiment of the present disclosure, the server 106 may include a group of one or more servers. A portion or all of operations performed in the electronic device 101 may be performed in one or more other electronic devices (e.g., the first electronic device 102, the second external electronic device 104, or the server 106). When the electronic device 101 should perform a certain function or service automatically or in response to a request, the electronic device 101 may request at least a portion of functions related to the function or service from another device (e.g., the first electronic device 102, the second external electronic device 104, or the server 106) instead of or in addition to performing the function or service for itself. The other electronic device (e.g., the first electronic device 102, the second external electronic device 104, or the server 106) may perform the requested function or additional function, and may transfer a result of the performance to the electronic device 101. The electronic device 101 may use a received result itself or additionally process the received result to provide the requested function or service. To this end, for example, a cloud computing technology, a distributed computing technology, or a client-server computing technology may be used.

FIG. 1B illustrates the configuration of an electronic device that detects an electronic pen according to various embodiments of the disclosure.

Referring to FIG. 1B, a display 160 that detects an input from the electronic pen 180 may be provided for the electronic device (101 in FIG. 1A). The display 160 may simultaneously support data input and output functions and may detect a touch.

The display 160 may include a touch panel 161, a display panel 162, and a display controller 163. The touch panel 161 may detect the position of a touch input, and the display panel 162 may output an image. For example, the touch panel 161 may receive an electromagnetic field from the electronic pen 180 and may detect the position of a touch on the basis thereof. The display controller 163 may be a driver circuit to control the display panel 162 in order to output an image through the display panel 162. A processor 120 may perform an operation associated with control and/or communication of at least one other component included in the electronic device 101 or may perform data processing. For example, the processor 120 may control the operations of the display controller 163 and a touch controller 164 to be described below and may be a central processing unit (CPU) or an application processor (AP).

According to one embodiment of the disclosure, the touch panel 161 may detect an electrical signal or a magnetic signal generated from various types of electronic pens 180. For example, the electronic pen 180 may be supplied with power for generating an electrical signal or a magnetic signal from a battery or a resonance circuit according to an electromagnetically an electromagnetic induction method. When approaching an electromagnetic field generated from the touch panel 161, the resonance circuit of the electronic pen 180 may generate an electric current and may form a magnetic field by the electric current. For example, the electronic pen 180 may support an active electrical stylus (AES) type including a battery, an electrically coupled resonance (ECR) type not including a battery, or an electromagnetic resonance (EMR) type. The AES type may apply an electrical signal directly to the touch panel 161. The ECR type and the EMR type may include a resonance circuit according to the electromagnetic induction method in the electronic pen 180. The resonance circuit inside the electronic panel of the ECR type may resonate an alternating current signal transmitted from the touch panel 161 by coupling or may transmit the resonated signal to the touch panel 161 by coupling. When approaching to an electromagnetic field generated from the touch panel 161, the resonance circuit inside the electronic pen of the EMR type may generate an electric current and may form a magnetic field by the generated electric current.

FIG. 1C and FIG. 1D are block diagrams illustrating the configuration of a touch panel that detects an electronic pen according to various embodiments of the disclosure.

Referring to FIG. 1C, the touch panel 161 may detect the touch or proximity of an electronic pen or a user's finger, may determine the coordinates of a position of the touch or proximity of the electronic pen or the user's finger, and may include a sensor 165 and a touch controller 164. The sensor 165 may receive a touch drive signal from the touch controller 164, may generate a touch detection signal that changes according to the touch or proximity of an input device, such as an electronic pen or a finger, and may provide the touch detection signal to the touch controller 164. The sensor 165 may include touch wiring including sensor electrodes, and the touch wiring may be disposed in an alternated and parallel manner in a touch area of the touch panel 161 and may be connected to the touch controller 164. The touch wiring may include a transparent conductive material or a low-resistivity material, such as a molybdenum (Mo), silver (Ag), titanium (Ti), copper (Cu), aluminum (Al), or molybdenum/aluminum/molybdenum (Mo/Al/Mo).

The touch controller 164 may provide a touch drive signal to the sensor 165, may receive a touch detection signal from the sensor 165, may generate touch information on the basis of the touch detection signal, and may provide the generated touch information to the processor 120. The touch information may be a stream of data values corresponding to positions where touches by the electronic pen or finger are detected. The touch information may further include pressure data indicating a pressure applied to the sensor 165.

According to one embodiment of the disclosure, the touch panel 161 may receive a voltage from the touch controller 164 and may form an electric field for touch detection. When the electronic pen 180 approaches the touch panel 161, the resonance circuit of the electronic pen 180 generates an electric current and may form a magnetic field by the electric current. The touch controller 164 may detect the position of a touch on the basis of a change in capacitance on the touch panel 161. The touch controller 164 may provide the detected position to the processor 120, and the processor 120 may perform an operation accordingly.

Referring to FIG. 1D, the touch panel 161 may include a touch controller 164, a first sensor 166, and a second sensor 167. For example, the first sensor 166 may be touch wiring including a sensor electrode or the like, and the second sensor 167 may be a digitizer pad 165. The first sensor 166 and the second sensor 167 may be positioned in different layers. For example, the first sensor 166 may be disposed on a display surface of the display panel 162, and the second sensor 167 may be disposed on the opposite surface of the display surface of the display panel 162. Since the first sensor 166 and the touch controller 164 operate in the same manner as those in FIG. 1C, a detailed description of these modules will be omitted in the following description.

According to one embodiment of the disclosure, the second sensor 167 may include lines formed in an alternated and parallel manner in x- and y-axis directions. The second sensor 167 may receive an alternating current from the touch controller 164 and may generate an electric field. When the electronic pen 180 approaches the second sensor 167, the resonance circuit of the electronic pen 180 may generate an electric current and may form a magnetic field by the electric current. The touch controller 164 may detect a position by scanning the strength of the magnetic field provided from the electronic pen 180 to the second sensor 167 across the entire area. The touch controller 164 may provide the detected position to the processor 120, and the processor 120 may perform an operation accordingly. Although the second sensor 167 is described as a component of the touch panel 161, the second sensor 167 may be disposed in the electronic device 101 as a separate component from the touch panel 161.

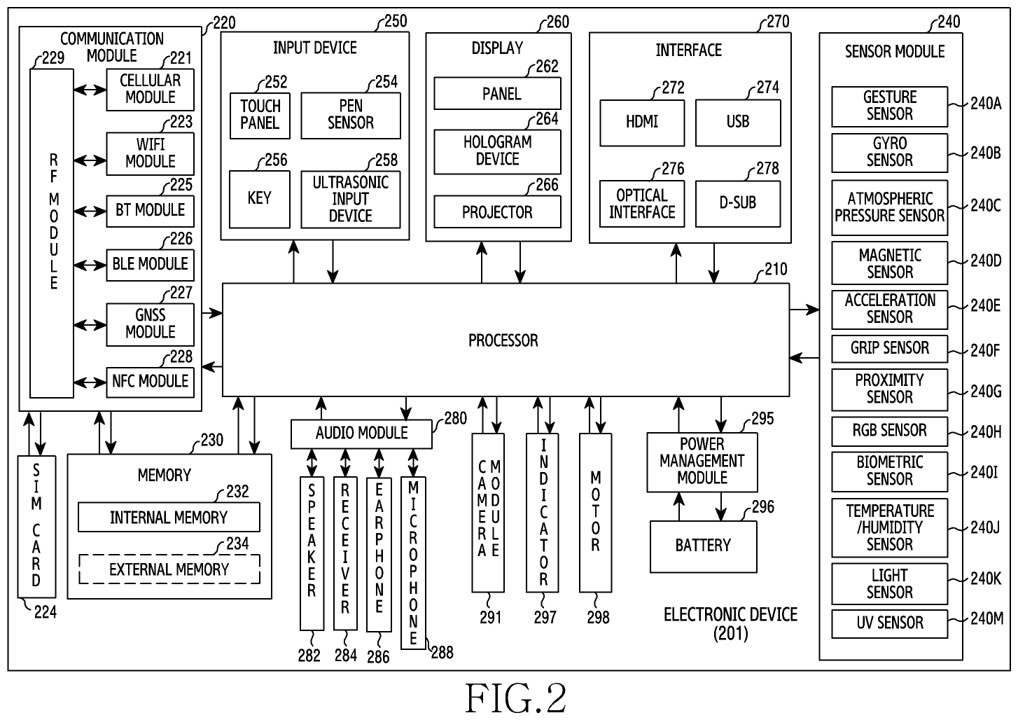

FIG. 2 is a block diagram illustrating an electronic device according to various embodiments of the disclosure.

Referring to FIG. 2, an electronic device 201 may include, for example, a part or the entirety of the electronic device 101 illustrated in FIG. 1A. The electronic device 201 may include at least one processor (e.g., AP) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may run an operating system or an application program so as to control a plurality of hardware or software elements connected to the processor 210, and may process various data and perform operations. The processor 210 may be implemented with, for example, a system on chip (SoC). According to an embodiment of the present disclosure, the processor 210 may further include a graphic processing unit (GPU) and/or an image signal processor. The processor 210 may include at least a portion (e.g., a cellular module 221) of the elements illustrated in FIG. 2. The processor 210 may load, on a volatile memory, an instruction or data received from at least one of other elements (e.g., a nonvolatile memory) to process the instruction or data, and may store various data in a nonvolatile memory.

The communication module 220 may have a configuration that is the same as or similar to that of the communication interface 170 of FIG. 1A. The communication module 220 may include, for example, a cellular module 221, a Wi-Fi module 223, a Bluetooth (BT) module 225, a Bluetooth Low energy module 226, a GNSS module 227, a NFC module 228, and a radio frequency (RF) module 229. The cellular module 221 may provide, for example, a voice call service, a video call service, a text message service, or an Internet service through a communication network. The cellular module 221 may identify and authenticate the electronic device 201 in the communication network using the subscriber identification module 224 (e.g., a SIM card). The cellular module 221 may perform at least a part of functions that may be provided by the processor 210. The cellular module 221 may include a communication processor (CP). According to some various embodiments of the present disclosure, at least a part (e.g., two or more) of the cellular module 221, the Wi-Fi module 223, the Bluetooth module 225, the Bluetooth Low energy module 226, the GNSS module 227, and the NFC module 228 may be included in a single integrated chip (IC) or IC package. The RF module 229 may transmit/receive, for example, communication signals (e.g., RF signals). The RF module 229 may include, for example, a transceiver, a power amp module (PAM), a frequency filter, a low noise amplifier (LNA), an antenna, or the like. According to another embodiment of the present disclosure, at least one of the cellular module 221, the Wi-Fi module 223, the Bluetooth module 225, the Bluetooth Low energy module 226, the GNSS module 227, or the NFC module 228 may transmit/receive RF signals through a separate RF module. The SIM 224 may include, for example, an embedded SIM and/or a card containing the subscriber identity module, and may include unique identification information (e.g., an integrated circuit card identifier (ICCID)) or subscriber information (e.g., international mobile subscriber identity (IMSI)).

The memory 230 (e.g., the memory 130) may include, for example, an internal memory 232 or an external memory 234. The internal memory 232 may include at least one of a volatile memory (e.g., a dynamic RAM (DRAM), a static RAM (SRAM), a synchronous dynamic RAM (SDRAM), or the like), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like)), a hard drive, or a solid state drive (SSD). The external memory 234 may include a flash drive such as a compact flash (CF), a secure digital (SD), a Micro-SD, a Mini-SD, an extreme digital (xD), a MultiMediaCard (MMC), a memory stick, or the like. The external memory 234 may be operatively and/or physically connected to the electronic device 201 through various interfaces.

The sensor module 240 may, for example, measure physical quantity or detect an operation state of the electronic device 201 so as to convert measured or detected information into an electrical signal. The sensor module 240 may include, for example, at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., a red/green/blue (RGB) sensor), a biometric sensor 240I, a temperature/humidity sensor 240J, an illumination sensor 240K, or an ultraviolet (UV) sensor 240M. Additionally or alternatively, the sensor module 240 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 240 may further include a control circuit for controlling at least one sensor included therein. In some various embodiments of the present disclosure, the electronic device 201 may further include a processor configured to control the sensor module 240 as a part of the processor 210 or separately, so that the sensor module 240 is controlled while the processor 210 is in a sleep state.

The input device 250 may include, for example, a touch panel 252, a (digital) pen sensor 254, a key 256, or an ultrasonic input device 258. The touch panel 252 may employ at least one of capacitive, resistive, infrared, and ultraviolet sensing methods. The touch panel 252 may further include a control circuit. The touch panel 252 may further include a tactile layer so as to provide a haptic feedback to a user. The (digital) pen sensor 254 may include, for example, a sheet for recognition which is a part of a touch panel or is separate. The key 256 may include, for example, a physical button, an optical button, or a keypad. The ultrasonic input device 258 may sense ultrasonic waves generated by an input tool through a microphone 288 so as to identify data corresponding to the ultrasonic waves sensed.

The display 260 (e.g., the display 160) may include a panel 262, a hologram device 264, or a projector 266. According to an embodiment of the present disclosure, the display 260 may further include a control circuit for controlling the panel 262, the hologram device 264, or the projector 266. The panel 262 may be, for example, flexible, transparent, or wearable. The panel 262 and the touch panel 252 may be integrated into a single module. The hologram device 264 may display a stereoscopic image in a space using a light interference phenomenon. The projector 266 may project light onto a screen so as to display an image. The screen may be disposed in the inside or the outside of the electronic device 201. The interface 270 may include, for example, an HDMI 272, a USB 274, an optical interface 276, or a D-subminiature (D-sub) 278. The interface 270, for example, may be included in the communication interface 170 illustrated in FIG. 1A. Additionally or alternatively, the interface 270 may include, for example, a mobile high-definition link (MHL) interface, an SD card/multi-media card (MMC) interface, or an infrared data association (IrDA) interface.

The audio module 280 may convert, for example, a sound into an electrical signal or vice versa. At least a portion of elements of the audio module 280 may be included in the input/output interface 150 illustrated in FIG. 1A. The audio module 280 may process sound information input or output through a speaker 282, a receiver 284, an earphone 286, or the microphone 288. The camera module 291 is, for example, a device for shooting a still image or a video. According to an embodiment of the present disclosure, the camera module 291 may include at least one image sensor (e.g., a front sensor or a rear sensor), a lens, an image signal processor (ISP), or a flash (e.g., an LED or a xenon lamp). The power management module 295 may manage power of the electronic device 201. According to an embodiment of the present disclosure, the power management module 295 may include a power management integrated circuit (PMIC), a charger integrated circuit (IC), or a battery or gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 296 and a voltage, current or temperature thereof while the battery is charged. The battery 296 may include, for example, a rechargeable battery and/or a solar battery.

The indicator 297 may display a specific state of the electronic device 201 or a part thereof (e.g., the processor 210), such as a booting state, a message state, a charging state, or the like. The motor 298 may convert an electrical signal into a mechanical vibration, and may generate a vibration or haptic effect. Although not illustrated, a processing device (e.g., a GPU) for supporting a mobile TV may be included in the electronic device 201. The processing device for supporting a mobile TV may process media data according to the standards of digital multimedia broadcasting (DMB), digital video broadcasting (DVB), MediaFLO™, or the like.

Each of the elements described herein may be configured with one or more components, and the names of the elements may be changed according to the type of an electronic device. In various embodiments of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

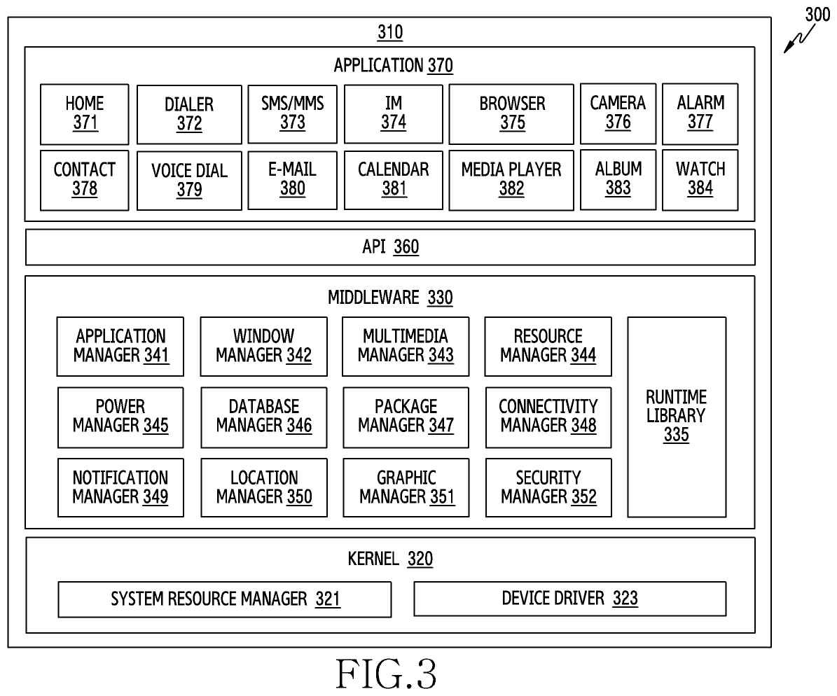

FIG. 3 is a block diagram illustrating a program module according to various embodiments.

Referring to FIG. 3, a program module 310 (e.g., the program 140) may include an operating system (OS) for controlling a resource related to an electronic device (e.g., the electronic device 101) and/or various applications (e.g., the application program 147) running on the OS. The operating system may be, for example, Android, iOS, Windows, Symbian, Tizen, or the like. The program module 310 may include a kernel 320, a middleware 330, an API 360, and/or an application 370. At least a part of the program module 310 may be preloaded on an electronic device or may be downloaded from an external electronic device (e.g., the first electronic device 102, the second external electronic device 104, or the server 106).

The kernel 320 (e.g., the kernel 141) may include, for example, a system resource manager 321 or a device driver 323. The system resource manager 321 may perform control, allocation, or retrieval of a system resource. According to an embodiment of the present disclosure, the system resource manager 321 may include a process management unit, a memory management unit, a file system management unit, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver. The middleware 330, for example, may provide a function that the applications 370 require in common, or may provide various functions to the applications 370 through the API 360 so that the applications 370 may efficiently use limited system resources in the electronic device. According to an embodiment of the present disclosure, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a complier uses to add a new function through a programming language while the application 370 is running. The runtime library 335 may perform a function for input/output management, memory management, or an arithmetic function. The application manager 341 may mange, for example, a life cycle of at least one of the applications 370. The window manager 342 may manage a GUI resource used in a screen. The multimedia manager 343 may recognize a format required for playing various media files and may encode or decode a media file using a codec matched to the format. The resource manager 344 may manage a resource such as a source code, a memory, or a storage space of at least one of the applications 370. The power manager 345, for example, may operate together with a basic input/output system (BIOS) to manage a battery or power and may provide power information required for operating the electronic device. The database manager 346 may generate, search, or modify a database to be used in at least one of the applications 370. The package manager 347 may manage installation or update of an application distributed in a package file format.

The connectivity manger 348 may manage wireless connection of Wi-Fi, Bluetooth, or the like. The notification manager 349 may display or notify an event such as message arrival, appointments, and proximity alerts in such a manner as not to disturb a user. The location manager 350 may manage location information of the electronic device. The graphic manager 351 may manage a graphic effect to be provided to a user or a user interface related thereto. The security manager 352 may provide various security functions required for system security or user authentication. According to an embodiment of the present disclosure, in the case in which an electronic device (e.g., the electronic device 101) includes a phone function, the middleware 330 may further include a telephony manager for managing a voice or video call function of the electronic device. The middleware 330 may include a middleware module for forming a combination of various functions of the above-mentioned elements. The middleware 330 may provide a module specialized for each type of an operating system to provide differentiated functions. Furthermore, the middleware 330 may delete a part of existing elements or may add new elements dynamically. The API 360 (e.g., the API 145) which is, for example, a set of API programming functions may be provided in different configurations according to an operating system. For example, in the case of Android or iOS, one API set may be provided for each platform, and, in the case of Tizen, at least two API sets may be provided for each platform.

The application 370 (e.g., the application program 147), for example, may include at least one application capable of performing functions such as a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, a watch 384, health care (e.g., measure an exercise amount or blood sugar), or environmental information provision (e.g., provide air pressure, humidity, or temperature information). According to an embodiment of the present disclosure, the application 370 may include an information exchange application for supporting information exchange between the electronic device (e.g., the electronic device 101) and an external electronic device (e.g., the first electronic device 102 or the second external electronic device 104). The information exchange application may include, for example, a notification relay application for relaying specific information to the external electronic device or a device management application for managing the external electronic device. For example, the notification relay application may have a function for relaying, to an external electronic device (e.g., the first electronic device 102 or the second external electronic device 104), notification information generated in another application (e.g., an SMS/MMS application, an e-mail application, a health care application, an environmental information application, or the like) of the electronic device. Furthermore, the notification relay application may receive notification information from the external electronic device and may provide the received notification information to the user. The device management application, for example, may manage (e.g., install, delete, or update) at least one function (e.g., turn-on/turn off of the external electronic device itself (or some elements) or the brightness (or resolution) adjustment of a display) of the external electronic device (e.g., the first electronic device 102 or the second external electronic device 104) communicating with the electronic device, an application running in the external electronic device, or a service (e.g., a call service, a message service, or the like) provided from the external electronic device. According to an embodiment of the present disclosure, the application 370 may include a specified application (e.g., a healthcare application of a mobile medical device) according to an attribute of the external electronic device (e.g., the first electronic device 102 or the second external electronic device 104). The application 370 may include an application received from an external electronic device (e.g., the first electronic device 102 or the second external electronic device 104). The application 370 may include a preloaded application or a third-party application downloadable from a server. The names of the elements of the program module 310 illustrated may vary with the type of an operating system. According to various embodiments of the present disclosure, at least a part of the program module 310 may be implemented with software, firmware, hardware, or a combination thereof. At least a part of the program module 310, for example, may be implemented (e.g., executed) by a processor (e.g., the processor 210). At least a part of the program module 310 may include, for example, a module, a program, a routine, sets of instructions, or a process for performing at least one function.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed. At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 120), the processor may perform functions corresponding to the instructions. The computer-readable storage medium may be, for example, the memory 130. A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa. A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

According to various embodiments of the disclosure, an electronic device may include: a sensor module; a processor configured to be electrically connected with the sensor module; and a memory configured to be electrically connected with the processor, wherein the memory may be configured to store instructions to, when executed, enable the processor to: detect a first electronic pen using the sensor module; detect release of the first electronic pen using the sensor module; and scan an electronic pen on the basis of an updated scan variable of the electronic pen on the basis of detection of the release of the first electronic pen.

According to various embodiments, the instructions may enable the processor to update the scan variable of the electronic pen, and an operation of updating the scan variable of the electronic pen may be performed after an operation of detecting the first electronic pen or an operation of detecting the release of the first electronic pen.

According to various embodiments, the instructions may enable the processor to update a priority of the electronic pen and to update the scan variable of the electronic pen on the basis of the updated priority.

According to various embodiments, the scan variable of the electronic pen may include a scan variable of the first electronic pen and a scan variable of a second electronic pen, and the instructions may enable the processor to update the scan variable of the first electronic pen and the scan variable of the second electronic pen.

According to various embodiments, the first electronic pen and the second electronic pen may operate on the basis of at least partly different protocols.

According to various embodiments, the instructions may enable the processor to adjust at least one of a scan driving frequency, a scan driving strength, a scan driving time, or a number of scan driving sensors on the basis of the updated scan variable.

According to various embodiments, the instructions may enable the processor to identify whether there is a usage history of the first electronic pen, and to update the scan variable of the electronic pen on the basis of the usage history of the first electronic pen when there is the usage history of the first electronic pen.

According to various embodiments, the instructions may enable the processor to update a scan variable of a designated electronic pen when there is no usage history of the first electronic pen.

According to various embodiments, the electronic device may further include a display, and the instructions may enable the processor to identify an electronic pen that is not used for a specified period or longer on the basis of a usage history of the electronic pen and to display a notification for selecting whether to deactivate the electronic pen that is not used for the specified period or longer using the display when the electronic pen that is not used for the specified period or longer is identified.

According to various embodiments, the electronic device may further include a communication module, and the instructions may enable the processor to detect a connection of a second electronic pen to the electronic device using the communication module and to update the scan variable of the electronic pen on the basis of detection of the connection of the second electronic pen to the electronic device.

According to various embodiments of the disclosure, an electronic device may include: a sensor module; a processor configured to be electrically connected with the sensor module; and a memory configured to be electrically connected with the processor, wherein the memory may be configured to store instructions to, when executed, enable the processor to: scan a first electronic pen using the sensor module; determine whether the first electronic pen is detected using the sensor module; update a scan variable of an electronic pen and determine whether release of the detected first electronic pen is detected when the first electronic pen is detected; scan a second electronic pen and determine whether the second electronic pen is detected using the sensor module when the first electronic pen is not detected; and update the scan variable of the electronic pen and determine whether release of the detected second electronic pen is detected when the second electronic pen is detected, and the first electronic pen and the second electronic pen may operate on the basis of at least partly different protocols.

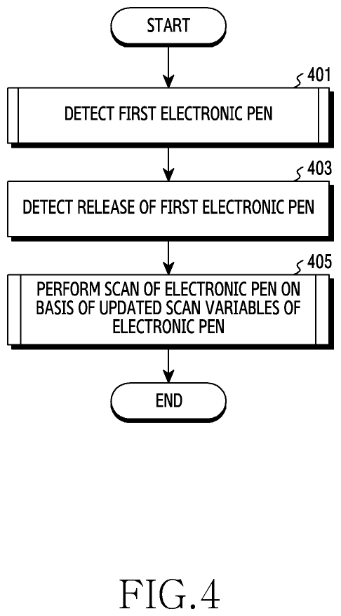

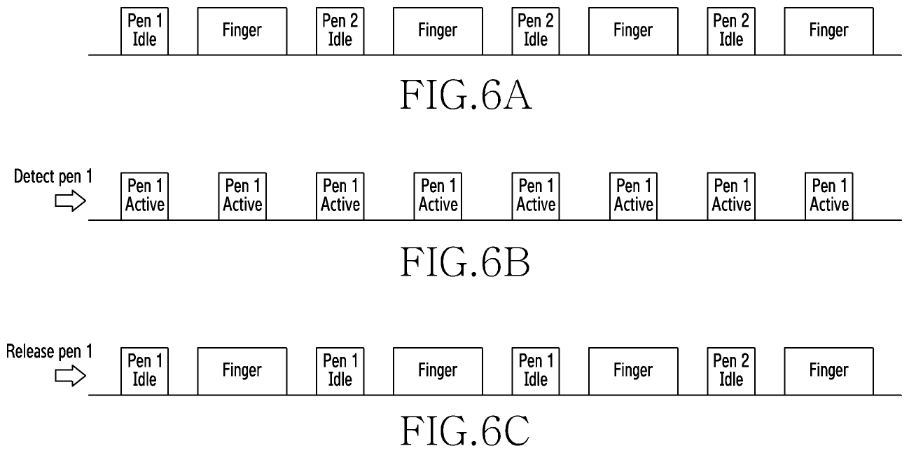

FIG. 4 is a flowchart illustrating an operating method of an electronic device according to various embodiments of the disclosure. FIG. 6 to FIG. 9 are diagrams for illustrating a method for updating a scan variable of an electronic pen according to various embodiments of the disclosure. In the following description, the electronic device may include the electronic device 101 of FIG. 1A or at least a part (e.g., the processor 120) of the electronic device 101.

Referring to FIG. 4, in operation 401, the electronic device 101 may detect a first electronic pen via a touch panel 161 (illustrated in FIG. 1C). For example, the processor 120 may scan various types of electronic pens according to a scan variable designated to detect the first electronic pen. For example, the type of an electronic pen may be determined according to a protocol applied to the electronic pen or the frequency of a signal provided to the touch panel 161. When the touch panel 161 cannot simultaneously scan various kinds of electronic pens, the processor 120 may drive the touch panel 161 by periodically changing a scan method corresponding to each electronic pen in order to detect various types of electronic pens. The scan method corresponding to the electronic pen may be a scan method suitable to detect the electronic pen. For example, the processor 120 may detect the first electronic pen while a first scan method is applied, and may detect a second electronic pen while the second scan method is applied.

For example, a scan variable may be a variable for determining the driving ratio of a scan method corresponding to an electronic pen, and the driving ratio may be determined by adjusting a scan driving frequency, a scan driving strength, a scan driving time, and the number of driven sensors according to the scan variable. The scan driving frequency may be the number of times the electronic pen is scanned for a certain time. The driving strength may be power required to detect a signal of the electronic pen. As the power for detecting the signal of the electronic pen increases, the distance that the touch panel 161 can detect the electronic pen increases, and the touch panel 161 can more easily detect the electronic pen. The scan driving time may be the time for which a plurality of electronic pens is scanned at a time. The number of driven sensors may refer to the number of sensor electrodes of the touch panel 161. That is, when scanning an electronic pen having a high priority, the processor 120 may increase the active ratio of sensor electrodes disposed on the touch panel 161.

For convenience of explanation, the first electronic pen and a second electronic pen will be illustrated as examples hereinafter. The first electronic pen and the second electronic pen may operate on the basis of different protocols or may provide signals having different frequencies within the same protocol to the touch panel 161. A protocol may be a rule for determining the type of a signal generated from an electronic pen, whether a battery is required, the type of a sensor for sensing an electronic pen, or the like. For example, the first electronic pen may be an electronic pen in an active electrical stylus (AES) type including a battery, and the second electronic pen may be an electronic pen in an electrically coupled resonance (ECR) method not including a battery. Further, the first electronic pen and the second electronic pen may be electronic pens provided for the electronic device 101 or pens provided for another electronic device. The electronic device 101 may preconfigure or add the type of a detectable electronic pen.

According to one embodiment of the disclosure, as illustrated in FIG. 6A, the electronic device 101 may repeatedly change a state in order of a first electronic pen idle mode, a finger idle mode, and a second electronic pen idle according to a specified scan variable. For example, the driving frequency of an idle mode may be specified according to the specified scan variable, and the processor 120 may drive the first electronic pen idle mode and the second electronic pen idle mode at a ratio of 1:3. An idle mode may refer to a state in which the processor 120 detects whether an electronic pen or a finger newly touches or approaches the touch panel 161 with an electronic pen or a finger not touching or approaching the touch panel 161. Each idle mode may refer to a state in which a corresponding electronic pen can be scanned.

Although not shown in the drawing, the idle mode may include a low-power idle mode, a high-power idle mode, or the like. The low-power idle mode may be a mode in which the processor 120 requires low power to execute an idle mode, and the high-power idle mode may be a mode in which the processor 120 requires high power to execute an idle mode.

For example, the processor 120 may detect the first electronic pen by scanning an electronic pen using the touch panel 161. The processor 120 may detect an input from the first electronic pen using the touch panel 161 in the first electronic pen idle mode. The input from the first electronic pen may be a hovering, a drawing, a tap, a double tap, or the like.

For example, the processor 120 may obtain at least one coordinate according to the first electronic pen detected using the touch panel 161. The processor 120 may further obtain the coordinates of the first electronic pen until release of the electronic pen is detected.

According to one embodiment of the disclosure, as illustrated in FIG. 6B, the electronic device 101 may change the state to a first electronic pen active mode according to the detection of the first electronic pen. For example, an active mode may refer to a state for obtaining a coordinate with a finger or an electronic pen touching or approaching the touch panel 161. The processor 120 may further obtain the coordinates of the first electronic pen while maintaining the active mode until the release of the electronic pen is detected. That is, the processor 120 may obtain the coordinates of the first electronic pen from the time when the first electronic pen is detected to the time when the release of the first electronic pen is detected.

Although not shown in the drawing, the processor 120 may change the state from the second electronic pen idle mode or the finger idle mode between the first electronic pen active modes and may detect whether the second electronic pen or the finger touch.

Although not shown in the drawing, the active mode may include an active hover mode, an active touch mode, or the like according to the input type of an electronic pen. In the active hover mode, an input from the electronic pen may be a hovering. In the active touch mode, an input from the electronic pen may be a touch.

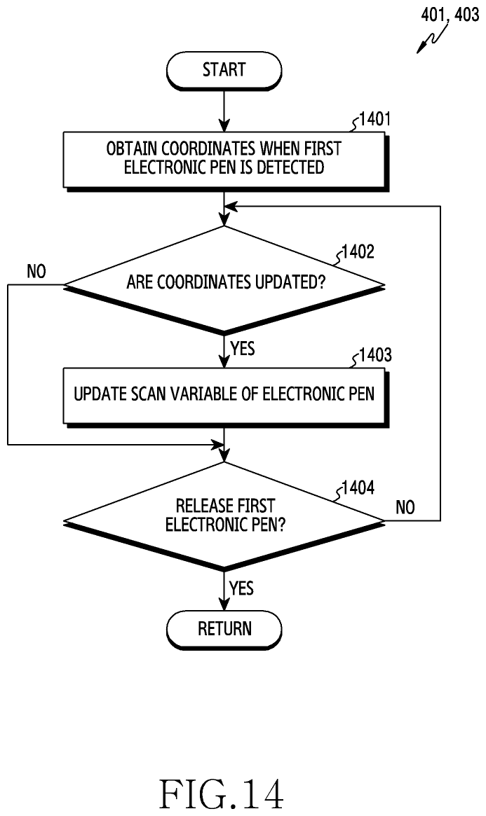

Although not shown in the drawing, the electronic device 101 may update a scan variable of an electronic pen when the first electronic pen is detected using the touch panel 161. For example, the processor 120 may increase a scan variable of the first electronic pen most recently detected and may decrease a scan variable of the second electronic pen. An operation of updating the scan variable of the electronic pen may be executed when the first electronic pen is detected, when the coordinates of the detected first electronic pen is obtained, or when the release of the first electronic pen is detected. Further, the processor 120 may update the scan variable of the electronic pen whenever the coordinates of the first electronic pen are additionally obtained, which will be described below with reference to FIG. 14.

In operation 403, the electronic device 101 may detect release of the first electronic pen through the touch panel 161. For example, the processor 120 may determine that the first electronic pen is released when the coordinates of the first electronic pen are not additionally obtained or the first electronic pen is not recognized through the touch panel 161 for a certain time or longer. For example, upon detecting the release of the first electronic pen, the processor 120 may scan an electronic pen on the basis of the updated scan variable of the electronic pen in operation 405 and may then terminate an algorithm according to the embodiment of the disclosure.

In operation 405, the electronic device 101 may scan an electronic pen on the basis of the updated scan variable of the electronic pen. For example, the processor 120 may determine the driving ratio of a scan method by adjusting a scan driving frequency, a scan driving strength, a scan driving time, and the number of driven sensors on the basis of the updated scan variable. According to an embodiment of the disclosure, as illustrated in FIG. 6C, the electronic device 101 may scan the electronic pen according to the increased driving frequency of the first electronic pen idle mode and the reduced driving frequency of the second electronic pen idle mode on the basis of the detection of the release of the first electronic pen. Accordingly, the detection speed of an electronic pen recently used may be improved. That is, it is possible to quickly detect a frequently used electronic pen by increasing the scan driving frequency of the frequently used electronic pen. In addition, since the processor 120 periodically changes the scan method, various types of electronic pens may be detected using one touch panel 164.

According to one embodiment of the disclosure, although not shown in the drawing, the electronic device 101 may increase the driving frequency of the first electronic pen idle mode by fixing the scan variable of the second electronic pen and increasing only the scan variable of the first electronic pen. Also, the electronic device 101 may increase the driving frequency of the first electronic pen idle mode to be higher than the driving frequency of the second electronic pen idle mode by fixing the scan variable of the first electronic pen and reducing the scan variable of the second electronic pen.

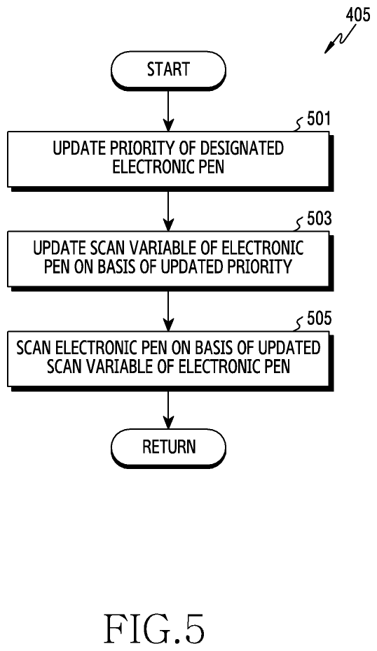

FIG. 5 is a flowchart illustrating a method for updating a scan variable of an electronic pen according to various embodiments of the disclosure. Hereinafter, an operation of scanning an electronic pen illustrated in operation 405 of FIG. 4 will be described. In the following description, an electronic device may include the electronic device 101 of FIG. 1A or at least a part (e.g., the processor 120) of the electronic device 101.

Referring to FIG. 5, in operation 501, the electronic device 101 may update the priority of a designated electronic pen. For example, a priority may be a concept for determining an electronic pen to be preferentially processed among a plurality of electronic pens and may be a criterion for setting or updating a scan variable corresponding to each of the plurality of electronic pens. The priority may be set in advance at the time of manufacturing the electronic device and may be set by a user input. The set priority of an electronic pen may be updated according to a user input or use of the electronic pen. For example, as illustrated in FIG. 6A, the priority may be set such that the first electronic pen has a higher priority than the second electronic pen, and a scan variable may be set such that the second electronic pen idle mode is more frequently driven than the first electronic pen idle mode according to the set priority.

In operation 503, the electronic device 101 may update a scan variable of an electronic pen on the basis of the updated priority. For example, as illustrated in FIG. 6C, the processor 120 may increase the driving frequency of the first idle mode to be higher than the driving frequency of the second idle mode on the basis of the updated scan variable.

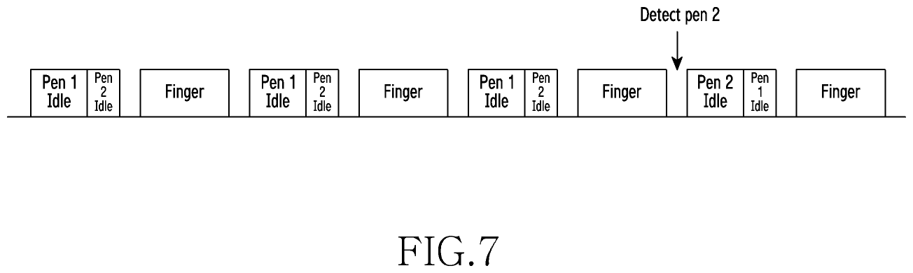

The operation of updating the scan variable may be performed by various methods. According to one embodiment, referring to FIG. 7, the electronic device 101 may update the ratio of the scan driving time of the electronic pen. For example, when the second electronic pen is detected with a ratio of 3:1 between the scan driving time of the first electronic pen and the scan driving time of the second electronic pen, which are periodically repeated, the processor 120 may update the ratio between the scan driving time of the first electronic pen and the scan driving time of the second electronic pen to 1:3.

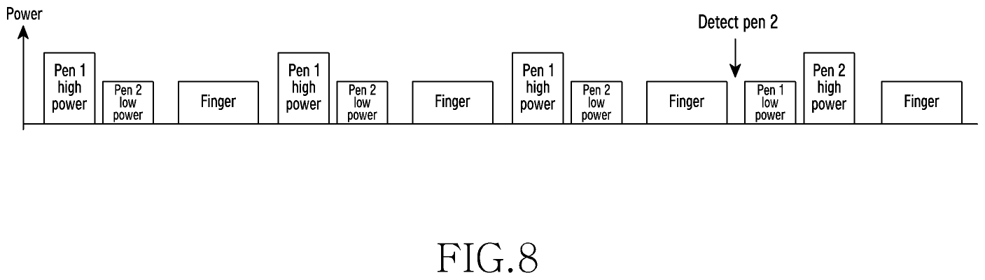

According to one embodiment, referring to FIG. 8, the electronic device 101 may update the power supply of the electronic pen. For example, the power supply of the electronic pen may be power required to scan the electronic pen. When the power supply of the electronic pen is high, the distance within which the electronic pen can be detected increases, and the electronic pen can be detected more easily. For example, when the second electronic pen is detected in a situation in which the first electronic pen is set to have high power and the second electronic pen is set to have low power, the processor 120 may update the power supply of the electronic pen so that the power supply of the first electronic pen is reduced and the power supply of the second electronic pen is increased.

In operation 505, the electronic device 101 may scan the electronic pen on the basis of the updated scan variable using the touch panel 161. For example, as illustrated in FIG. 6C, the processor 120 may drive the first electronic pen idle mode and the second electronic pen idle mode at a ratio of 3:1.

According to one embodiment of the disclosure, the electronic device 101 may omit operation 501 and may update the scan variable of the electronic pen without setting a priority in operation 503. For example, the processor 120 may increase the scan driving ratio of a frequently used electronic pen as the scan variable is updated without setting a priority.

According to one embodiment of the disclosure, although not shown in the drawing, when the first electronic pen and the second electronic pen are simultaneously detected on the basis of the changed priority, the electronic device 101 may select an input from the first electronic pen having a higher priority and may obtain the coordinates. Meanwhile, when electronic pens having protocols compatible with each other are simultaneously detected, the electronic device 101 may select inputs from all the electronic pens regardless of priority and may obtain the coordinates.

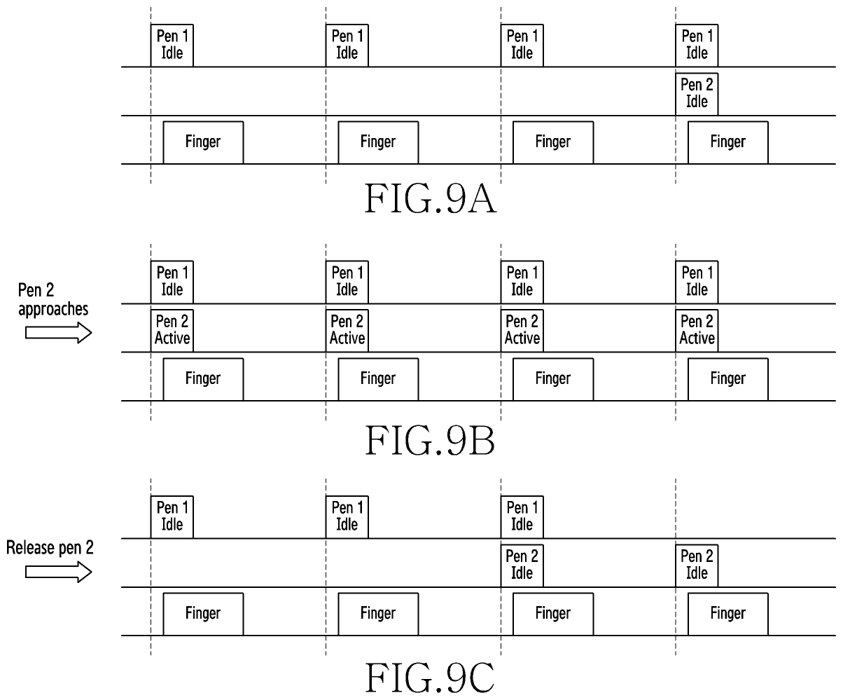

According to one embodiment of the disclosure, referring to FIG. 9, the electronic device 101 may scan various types of electronic pens according to a specified scan variable using a first sensor 166 (illustrated in FIG. 1D) and a second sensor 167 (illustrated in FIG. 1D). For example, the second sensor 167 may include a first digitizer pad used for scanning the first electronic pen and a second digitizer pad used for scanning the second electronic pen. For example, as illustrated in FIG. 9A, the first digitizer pad and the second digitizer pad may be driven at a ratio of 4:1. That is, while the first digitizer pad drives the first electronic pen idle mode four times, the second digitizer pad may drive the second electronic pen idle mode once. The processor 120 may periodically scan a finger using the touch panel 161.

The electronic device 101 may detect the second electronic pen using the second digitizer pad. For example, the processor 120 may obtain at least one coordinate according to the second electronic pen detected using the second digitizer pad. As illustrated in FIG. 9B, when the second electronic pen is detected, the processor 120 may change the second digitizer pad to a second electronic pen active mode. As the second digitizer pad is changed to the second electronic active mode, the processor 120 may obtain the coordinates of the second electronic pen. Although not shown in the drawing, the processor 120 may scan the first electronic pen through the first digitizer pad and may scan a finger through the first sensor 166 while obtaining the coordinates of the second electronic pen.

The electronic device 101 may detect release of the second electronic pen through the second digitizer pad, and may update the scan variable of the electronic pen on the basis of the detection of the release of the second electronic pen. For example, as illustrated in FIG. 9C, the processor 120 may increase the driving frequency of the second electronic pen idle mode and may reduce the driving frequency of the first electronic pen idle mode on the basis of the detection of the release of the second electronic pen. Although not shown in the drawing, the processor 120 may only reduce the driving frequency of the first electronic pen idle mode or may only increase the driving frequency of the second electronic pen idle mode on the basis of the detection of the release of the second electronic pen.

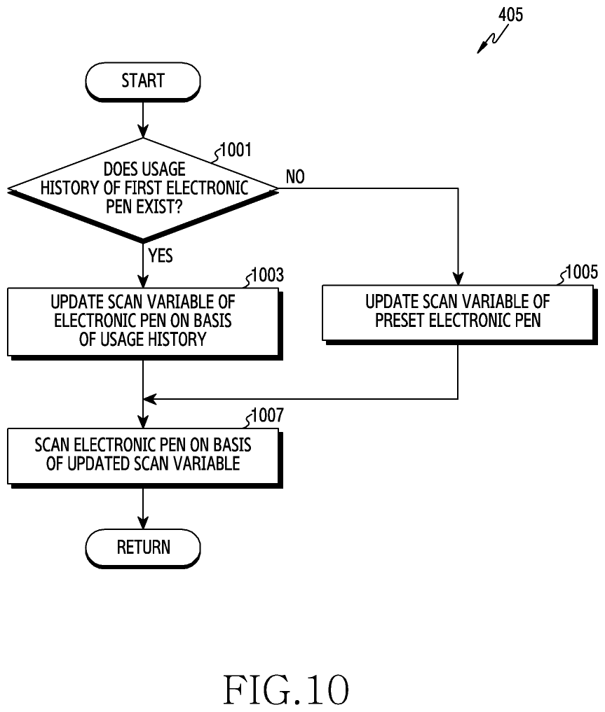

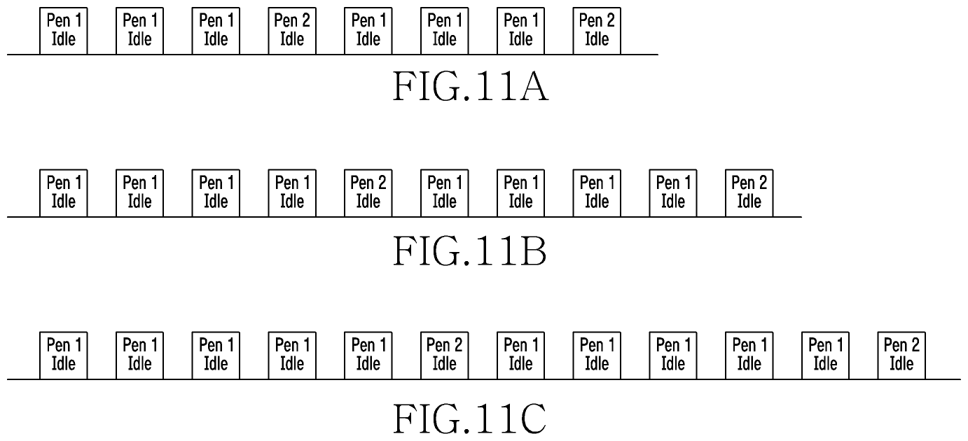

FIG. 10 is a flowchart illustrating a method for updating a scan variable of an electronic pen on the basis of a usage history according to various embodiments of the disclosure. FIG. 11 is a diagram for illustrating a method for updating a scan variable of an electronic pen on the basis of a usage history according to various embodiments of the disclosure. Hereinafter, an operation of scanning an electronic pen illustrated in operation 405 of FIG. 4 will be described. In the following description, an electronic device may include the electronic device 101 of FIG. 1A or at least a part (e.g., the processor 120) of the electronic device 101.

Referring to FIG. 10, in operation 1001, the electronic device 101 may check the usage history of a first electronic pen. For example, the processor 120 may check the usage history of the electronic pen generated in the electronic device in a memory of the electronic device 101. The usage history of an electronic pen may be information that accumulatively stores records of at least one coordinate obtained when the electronic pen is detected by the electronic device. The usage history of the electronic pen may be an input record of the electronic pen for a set period, and the set period may be set by a user or may be set in advance at the time of manufacturing. The usage history of the electronic pen may be periodically deleted.

When there is no usage history of the first electronic pen, the electronic device 101 may update a scan variable of a designated electronic pen in operation 1005, may scan the electronic pen on the basis of the updated scan variable in operation 1007, and may then terminate an algorithm according to the embodiment of the disclosure. The scan variable of the designated electronic pen may be a preset value on the assumption of an initial input from the first electronic pen.

When there is the usage history of the first electronic pen, the electronic device 101 may update the scan variable on the basis of the usage history of the first electronic pen in operation 1003. For example, the processor 120 may check the usage history of the first electronic pen, and may increase the scan driving frequency of the first electronic pen if the existing number of times the first electronic pen is used is high. For example, when the number of times the first electronic pen is used is less than a reference range, the processor 120 may update the ratio in scan driving frequency between the first electronic pen and the second electronic pen to 3:1 as illustrated in FIG. 11A. When the number of times the first electronic pen is used is within the reference range, the processor 120 may update the ratio in scan driving frequency between the first electronic pen and the second electronic pen to 4:1 as illustrated in FIG. 11B. When the number of times the first electronic pen is used exceeds the reference range, the processor 120 may update the ratio in scan driving frequency between the first electronic pen and the second electronic pen to 5:1 as illustrated in FIG. 11C.

In operation 1007, the electronic device 101 may scan the electronic pen on the basis of the scan variable updated on the basis of the usage history and may then terminate the algorithm according to the embodiment of the disclosure.

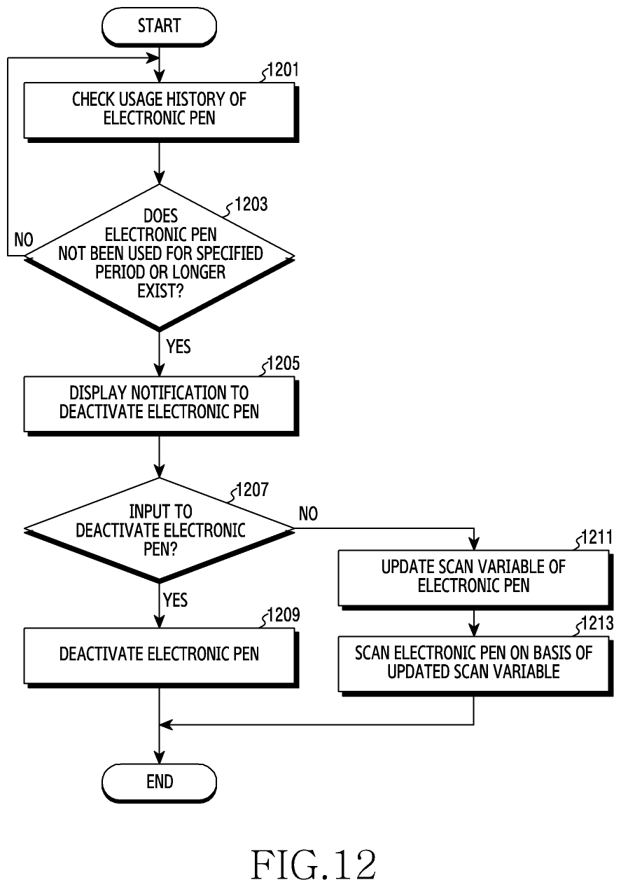

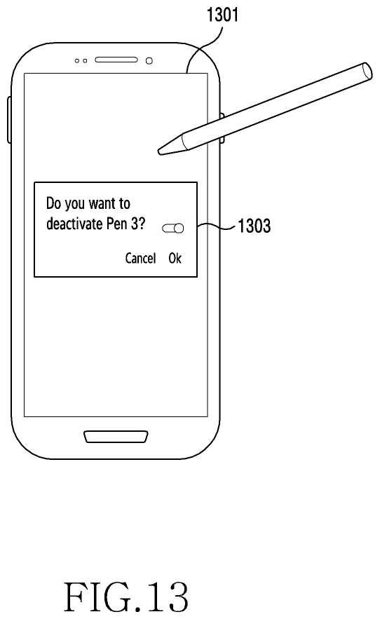

FIG. 12 is a flowchart illustrating a method for deactivating an electronic pen according to various embodiments of the disclosure. FIG. 13 illustrates a method for deactivating an electronic pen according to various embodiments of the disclosure. In the following description, an electronic device may include the electronic device 101 of FIG. 1A or at least a part (e.g., the processor 120) of the electronic device 101.

Referring to FIG. 12, in operation 1201, the electronic device 101 may check the usage history of an electronic pen. For example, the processor 120 may update the usage history of the electronic pen whenever the electronic pen is detected. The processor 120 may periodically check the usage history of the electronic pen.

In operation 1203, the electronic device 101 may identify an electronic pen that has not been used for a specified period or longer. For example, the specified period may be set by a user or may be set in advance at the time of manufacturing. The specified period may be determined by calculating a certain period for which the probability that the electronic pen is no longer used is increased on the basis of the usage history.

When there is no electronic pen that has not been used for the specified period or longer, the electronic device 101 may periodically check the usage history of the electronic pen in operation 1201.

When there is an electronic pen that has not been used for the specified period or longer, the electronic device 101 may display a notification for selecting whether to deactivate the electronic pen on a display panel 162 (illustrated in FIG. 1B) in operation 1205. For example, when the processor 120 determines that a third electronic pen has not been used for the specified period or longer, the processor 120 may transmit a signal including information about the third electronic pen to a display controller 163, and the display controller 163 may display a notification 1303 for selecting whether to deactivate the third electronic pen through a screen 1301 on the display panel 162 as illustrated in FIG. 13.

In operation 1207, the electronic device 101 may determine whether a user's input to deactivate the electronic pen is detected using the touch panel 161. For example, when an input to drag an object displayed on a notification for deactivating the third electronic pen and an input to touch a confirmation icon are detected, the processor 120 may determine that an input to deactivate the third electronic pen is detected.

When the user's input to deactivate the electronic pen is detected, the electronic device 101 may deactivate the electronic pen in operation 1209 and may then terminate an algorithm according to the embodiment of the disclosure. Accordingly, even when the deactivated electronic pen touches or approaches the touch panel 161, the processor 120 may not detect the deactivated electronic pen. The deactivated electronic pen may be reactivated by the user's setup.

When the user's input to deactivate the electronic pen is not detected, the electronic device 101 may update a scan variable of the electronic pen that has not been used for the specified period or longer in operation 1211. For example, the processor 120 may reduce the scan variable of the electronic pen that has not been used for the specified period or longer and may increase a scan variable of an electronic pen that is identified to be frequently used on the basis of the usage history. Alternatively, the processor 120 may reduce only the scan variable of the electronic pen that has not been used for the specified period.

The electronic device 101 may scan the electronic pen on the basis of the updated scan variable in operation 1213 and may then terminate the algorithm according to the embodiment of the disclosure. Accordingly, the electronic device 101 can improve the recognition speed of a frequently used electronic pen by deactivating an electronic pen that has not been used for a specified period or updating a scan variable.

According to one embodiment of the disclosure, when the user's input to deactivate the electronic pen is not detected, the electronic device 101 may periodically recheck the usage history of the electronic pen or may terminate the operation instead of performing operations 1211 and 1213. However, the disclosure is not limited thereto.

FIG. 14 is a flowchart illustrating a method for updating a scan variable of an electronic pen according to various embodiments of the disclosure. Hereinafter, an operation of updating a scan variable of an electronic pen illustrated in operations 401 and 403 of FIG. 4 will be described. In the following description, an electronic device may include the electronic device 101 of FIG. 1A or at least a part (e.g., the processor 120) of the electronic device 101.

Referring to FIG. 14, in operation 1401, the electronic device 101 may obtain a coordinate when detecting a first electronic pen. For example, the processor 120 may obtain the coordinates of the first electronic pen until release of the first electronic pen is detected.

In operation 1402, the electronic device 101 may determine whether the coordinates of the first electronic pen are updated. For example, the processor 120 may determine whether different coordinates from the already obtained coordinates are additionally obtained.

When it is determined that the coordinates of the first electronic pen are updated, the electronic device 101 may update a scan variable of an electronic pen in operation 1403. In operation 1404, the electronic device 101 may determine whether the first electronic pen is released using the touch panel 161. When it is determined that the first electronic pen is released, the electronic device 101 may return to operation 405 of FIG. 4 and may scan an electronic pen on the basis of the updated scan variable. When it is determined that the first electronic pen is not released, the electronic device 101 may identify whether the coordinates of the first electronic pen are updated.

When it is determined that the coordinates of the first electronic pen are not updated, the electronic device 101 may immediately perform operation 1404. When release of the first electronic pen is detected, the electronic device 101 may return to operation 405 of FIG. 4 and may scan an electronic pen on the basis of the updated scan variable. When it is determined that the first electronic pen is not released, the electronic device 101 may identify whether the coordinates of the first electronic pen are updated.

According to one embodiment of the disclosure, the electronic device 101 may update the scan variable of the electronic pen according to the number of times the coordinates of the first electronic pen are obtained. For example, the processor 120 may update the scan variable of the electronic pen whenever the coordinates of the first electronic pen are additionally obtained. Therefore, the greater the number of times the coordinates of the first electronic pen are obtained, the higher the scan driving ratio of the first electronic pen is. The processor 120 may record the number of times the coordinates of the first electronic pen are obtained, and may update the scan variable of the electronic pen immediately when the first electronic pen is released. When the scan variable reaches a certain value as the number of times the coordinates are obtained increases, the processor 120 may stop updating the scan variable.

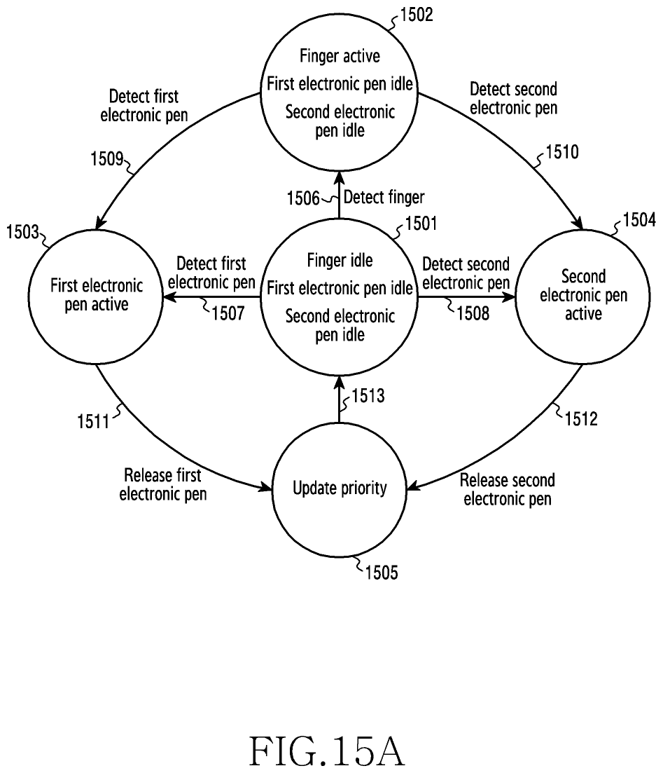

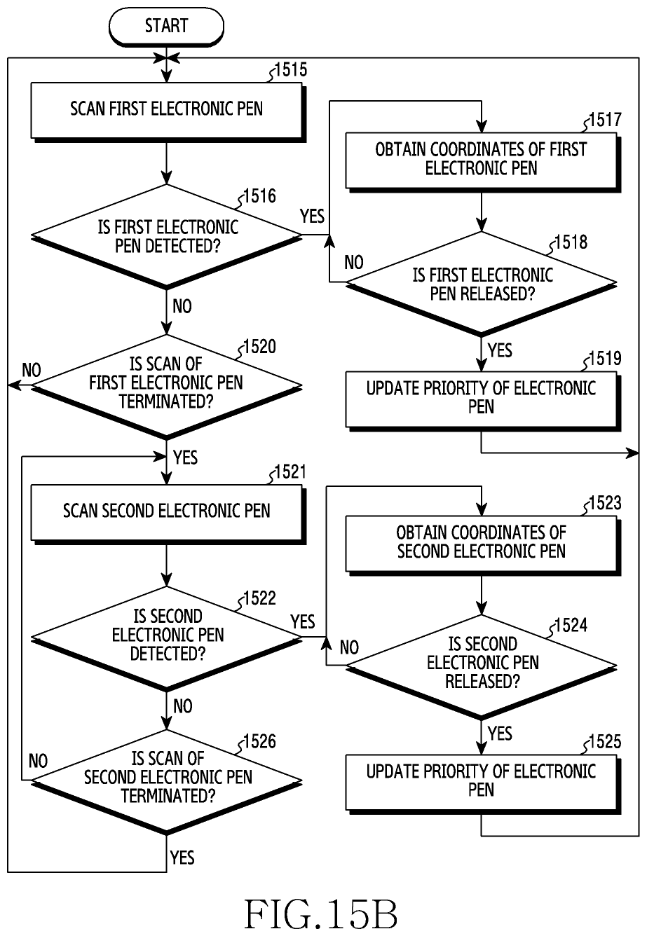

FIG. 15A and FIG. 15B are flowcharts illustrating an operating method of an electronic device according to various embodiments of the disclosure. In the following description, the electronic device may include the electronic device 101 of FIG. 1A or at least a part (e.g., the processor 120) of the electronic device 101.

Referring to FIG. 15A, the electronic device 101 may periodically change a state to a first electronic pen idle mode, a second electronic pen idle mode, and a finger idle mode in state 1501.

When the electronic device 101 detects a finger using a touch panel 161 (1506), the electronic device 101 may transition from state 1501 to state 1502. Further, when the electronic device 101 detects a first electronic pen using the touch panel 161 (1507), the electronic device 101 may transition to state 1503. In addition, when the electronic device 101 detects a second electronic pen using the touch panel 161 (1508), the electronic device 101 may transition to state 1504.

The electronic device 101 may operate in a finger active mode in state 1502. For example, the processor 120 may obtain the coordinates of the detected finger, and may operate in the first electronic pen idle mode or the second electronic pen idle mode while operating in the finger active mode. Accordingly, the processor 120 may transition to state 1503 when detecting a first electronic pen using the touch panel 161 (1509), and may transition to state 1504 when detecting a second electronic pen using the touch panel 161 (1510). While the state is changed by detecting the first electronic pen or the second electronic pen in state 1502, the processor 120 may continuously obtain the coordinates of the finger, or may alternatively exclude an input from the finger.

The electronic device 101 may operate in a first electronic pen active mode in state 1503. For example, the processor 120 may obtain the coordinates of the first electronic pen in the first electronic pen active mode. When detecting release of the first electronic pen (1511), the processor 120 may transition to state 1505.

The electronic device 101 may operate in a second electronic pen active mode in state 1504. For example, the processor 120 may obtain the coordinates of the second electronic pen in the second electronic pen active mode. When detecting release of the second electronic pen (1512), the processor 120 may transition to state 1505.

The electronic device 101 may update the priority of the first electronic pen or the second electronic pen in state 1505. For example, the processor 120 may transition to state 1501 on the basis of the updated priority, and may operate by changing (1513) to the finger idle mode, the first electronic pen idle mode, and the second electronic pen idle mode on the basis of the updated priority in state 1501.

Referring to FIG. 15B, in operation 1515, the electronic device 101 may scan the first electronic pen.

In operation 1516, the electronic device 101 may determine whether the first electronic pen is detected using the touch panel 161.

When the first electronic pen is detected, the electronic device 101 may obtain the coordinates of the first electronic pen in operation 1517 and may identify whether the first electronic pen is released in operation 1518.

When release of the first electronic pen is not detected, the electronic device 101 may repeat operation 1517.

When the release of the first electronic pen is detected, the electronic device 101 may update the priority of an electronic pen in operation 1519. The electronic device 101 may perform operation 1515 after operation 1519.

When the first electronic pen is not detected in operation 1516, the electronic device 101 may terminate scanning the first electronic pen in operation 1520.

When scan of the first electronic pen is not terminated, the electronic device 101 may continuously scan the first electronic pen.

When the scan of the first electronic pen is terminated, the electronic device 101 may scan the second electronic pen in operation 1521.

In operation 1522, the electronic device 101 may determine whether the second electronic pen is detected using the touch panel 161.

When the second electronic pen is detected, the electronic device 101 may obtain the coordinates of the second electronic pen in operation 1523 and may identify whether the second electronic pen is released in operation 1524.

When release of the second electronic pen is not detected, the electronic device 101 may repeat operation 1523.

When the release of the second electronic pen is detected, the electronic device 101 may update the priority of the electronic pen in operation 1525. The processor 120 may perform operation 1515 after operation 1525.

When the second electronic pen is not detected in operation 1522, the electronic device 101 may terminate scanning the second electronic pen in operation 1526. When scan of the second electronic pen is not terminated, the electronic device 101 may continuously scan the second electronic pen. When the scan of the second electronic pen is terminated, the electronic device 101 may scan the first electronic pen in operation 1515.

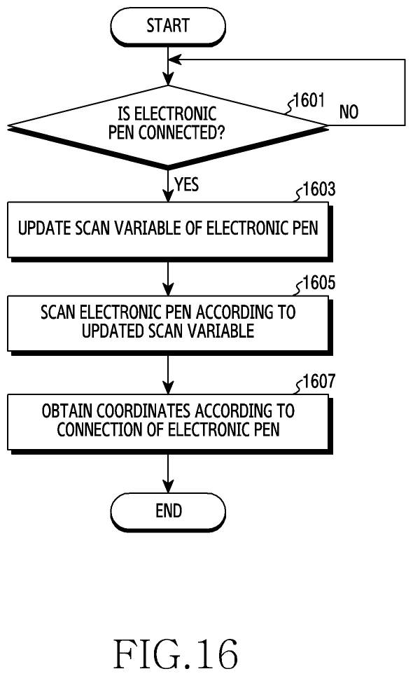

FIG. 16 is a flowchart illustrating a method for updating a scan variable of a connected electronic pen according to various embodiments of the disclosure. In the following description, an electronic device may include the electronic device 101 of FIG. 1A or at least a part (e.g., the processor 120) of the electronic device 101.

Referring to FIG. 16, in operation 1601, the electronic device 101 may determine whether an electronic pen is connected to the electronic device 101. For example, the electronic pen may be connected to the electronic device using a short-range communication method, such as Bluetooth. The processor 120 may determine whether the electronic pen is connected to the electronic device using a communication module.

When it is detected that no electronic pen is connected to the electronic device, the electronic device 101 may periodically determine whether an electronic pen is connected to the electronic device using the communication module.

When it is detected that the electronic pen is connected to the electronic device, the electronic device 101 may update a scan variable of the electronic pen in operation 1603, may scan the electronic pen on the basis of the updated scan variable in operation 1605, and may obtain the coordinates of the connected electronic pen in operation 1607. For example, the processor 120 may scan the electronic pen on the basis of the updated scan variable according to the connection of the electronic pen, and may obtain at least one coordinate of the connected electronic pen as the electronic pen is scanned. Then, the processor 120 may terminate an algorithm according to the embodiment of the disclosure. Accordingly, it is possible to improve the recognition speed of an electronic pen frequently connected to the electronic device.

According to various embodiments of the disclosure, an operating method of an electronic device using various types of electronic pens may include: detecting a first electronic pen; detecting release of the first electronic pen; and scanning an electronic pen on the basis of an updated scan variable of the electronic pen on the basis of detection of the release of the first electronic pen.

According to various embodiments of the disclosure, the method may further include updating the scan variable of the electronic pen, wherein the updating of the scan variable of the electronic pen may be performed after the detecting of the first electronic pen or the detecting of the release of the first electronic pen.

According to various embodiments of the disclosure, the scanning of the electronic pen may include: updating a priority of the electronic pen; and updating the scan variable of the electronic pen on the basis of the updated priority.

According to various embodiments of the disclosure, the scan variable of the electronic pen may include a scan variable of the first electronic pen and a scan variable of a second electronic pen, and the updating of the scan variable of the electronic pen may update the scan variable of the first electronic pen and the scan variable of the second electronic pen.

According to various embodiments of the disclosure, the first electronic pen and the second electronic pen may operate on the basis of at least partly different protocols.

According to various embodiments of the disclosure, the method may further include adjusting at least one of a scan driving frequency, a scan driving strength, a scan driving time, or a number of scan driving sensors on the basis of the updated scan variable.

According to various embodiments of the disclosure, the updating of the scan variable of the electronic pen may include: identifying whether there is a usage history of the first electronic pen; and updating the scan variable of the electronic pen on the basis of the usage history of the first electronic pen when there is the usage history of the first electronic pen.

According to various embodiments of the disclosure, the updating of the scan variable of the electronic pen may further include updating a scan variable of a designated electronic pen when there is no usage history of the first electronic pen.

According to various embodiments of the disclosure, the method may further include: identifying a usage history of the electronic pen; identifying an electronic pen that is not used for a specified period or longer on the basis of the usage history of the electronic pen; and displaying a notification for selecting whether to deactivate the electronic pen that is not used for the specified period or longer when the electronic pen that is not used for the specified period or longer is identified.

According to various embodiments of the disclosure, the method may further include: detecting a connection of a second electronic pen to the electronic device; and updating the scan variable of the electronic pen on the basis of detection of the connection of the second electronic pen to the electronic device.

According to various embodiments of the disclosure, an operating method of an electronic device may include: scanning a first electronic pen; determining whether the first electronic pen is detected; updating a scan variable of an electronic pen and determining whether release of the detected first electronic pen is detected when the first electronic pen is detected; scanning a second electronic pen and determining whether the second electronic pen is detected when the first electronic pen is not detected; and updating the scan variable of the electronic pen and determining whether release of the detected second electronic pen is detected when the second electronic pen is detected, and the first electronic pen and the second electronic pen may operate on the basis of at least partly different protocols.

1. An operating method of an electronic device using various types of electronic pens, the method comprising:
detecting a first electronic pen;
detecting release of the first electronic pen; and
scanning an electronic pen on the basis of an updated scan variable of the electronic pen on the basis of detection of the release of the first electronic pen.

2. The method as claimed in claim 1, further comprising updating the scan variable of the electronic pen,
wherein the updating of the scan variable of the electronic pen is performed after the detecting of the first electronic pen or the detecting of the release of the first electronic pen.

3. The method as claimed in claim 1, wherein the scanning of the electronic pen comprises: updating a priority of the electronic pen; and updating the scan variable of the electronic pen on the basis of the updated priority.

4. The method as claimed in claim 2, wherein the scan variable of the electronic pen comprises a scan variable of the first electronic pen and a scan variable of a second electronic pen, and
the updating of the scan variable of the electronic pen updates the scan variable of the first electronic pen and the scan variable of the second electronic pen.

5. An electronic device comprising:
a sensor module;
a processor configured to be electrically connected with the sensor module; and
a memory configured to be electrically connected with the processor,
wherein the memory is configured to store instructions to, when executed, enable the processor to:
detect a first electronic pen using the sensor module;
detect release of the first electronic pen using the sensor module; and
scan an electronic pen on the basis of an updated scan variable of the electronic pen on the basis of detection of the release of the first electronic pen.

6. The electronic device as claimed in claim 5, wherein the instructions enable the processor to update the scan variable of the electronic pen, and
an operation of updating the scan variable of the electronic pen is performed after an operation of detecting the first electronic pen or an operation of detecting the release of the first electronic pen.

7. The electronic device as claimed in claim 5, wherein the instructions enable the processor to update a priority of the electronic pen and to update the scan variable of the electronic pen on the basis of the updated priority.

8. The electronic device as claimed in claim 5, wherein the scan variable of the electronic pen comprises a scan variable of the first electronic pen and a scan variable of a second electronic pen, and
the instructions enable the processor to update the scan variable of the first electronic pen and the scan variable of the second electronic pen.

9. The electronic device as claimed in claim 8, wherein the first electronic pen and the second electronic pen operate on the basis of at least partly different protocols.

10. The electronic device as claimed in claim 5, wherein the instructions enable the processor to adjust at least one of a scan driving frequency, a scan driving strength, a scan driving time, or a number of scan driving sensors on the basis of the updated scan variable.

11. The electronic device as claimed in claim 5, wherein the instructions enable the processor to identify whether there is a usage history of the first electronic pen, and to update the scan variable of the electronic pen on the basis of the usage history of the first electronic pen when there is the usage history of the first electronic pen.

12. The electronic device as claimed in claim 11, wherein the instructions enable the processor to update a scan variable of a designated electronic pen when there is no usage history of the first electronic pen.

13. The electronic device as claimed in claim 5, further comprising a display,
wherein the instructions enable the processor to identify an electronic pen that is not used for a specified period or longer on the basis of a usage history of the electronic pen and to display a notification for selecting whether to deactivate the electronic pen that is not used for the specified period or longer using the display when the electronic pen that is not used for the specified period or longer is identified.

14. The electronic device as claimed in claim 5, further comprising a communication module,
wherein the instructions enable the processor to detect a connection of a second electronic pen to the electronic device using the communication module and to update the scan variable of the electronic pen on the basis of detection of the connection of the second electronic pen to the electronic device.

15. An electronic device comprising:
a sensor module;
a processor configured to be electrically connected with the sensor module; and
a memory configured to be electrically connected with the processor,
wherein the memory is configured to store instructions to, when executed, enable the processor to:
scan a first electronic pen using the sensor module;
determine whether the first electronic pen is detected using the sensor module;
update a scan variable of an electronic pen and determine whether release of the detected first electronic pen is detected when the first electronic pen is detected;
scan a second electronic pen and determine whether the second electronic pen is detected using the sensor module when the first electronic pen is not detected; and
update the scan variable of the electronic pen and determine whether release of the detected second electronic pen is detected when the second electronic pen is detected, and
the first electronic pen and the second electronic pen operate on the basis of at least partly different protocols.
